(19) United States
(12) Patent Application Publication
(10) Pub. No.: US 2025/0021657 A1
(43) Pub. Date: Jan. 16, 2025

(54) SYSTEMS AND METHODOLOGIES FOR AUTO LABELING VULNERABILITIES

(71) Applicant: CloudBlue LLC, Irvine, CA (US)

(72) Inventors: Evgenii ANDRIUKHIN, Sofia (BG); Ilya KOSTYULIN, Barcelona (ES)

(21) Appl. No.: 18/350,055

(22) Filed: Jul. 11, 2023

(51) Int. Cl. G06F 21/57

(52) U.S. Cl. CPC G06F 21/577; G06F 2221/033

(57) ABSTRACT

A system and methodology for automated security assessment of microservices includes a microservice composition model, data gathering, security assessment, and labeling components. It treats microservices as separate projects, collecting source code, dependencies, and runtime information. The security assessment employs tools to analyze code, track vulnerabilities, and identify risks. Predefined rules categorize microservices and assign security state labels. A hidden Markov model predicts security states based on historical data, enabling proactive security management and risk mitigation.

### BACKGROUND

In the complex landscape of cloud computing and microservice architecture, ensuring the security of software applications has become increasingly challenging. Traditional methods of application security often struggle to keep pace with the complexities and dynamics of modern software development practices. Conventional methods fail to effectively address security risks in cloud-based microservice environments.

Such conventional methods for application security typically rely on manual code reviews, penetration testing, and periodic security assessments. While these approaches have proven to be valuable, they often fall short when it comes to the unique challenges posed by microservice-based architectures. The conventional methods face several limitations, including lack of scalability, limited visibility, time lag in vulnerability detection, and inefficiency in addressing dependencies, leading to potential security gaps.

### BRIEF SUMMARY OF THE INVENTION

Embodiments described herein provide a system and methodology for performing automated security assessment of microservices in a Cloud Platform. The system and methodology offer several advantages, including comprehensive analysis of multiple layers, accurate risk scoring, proactive security management, and improved collaboration between teams.

In some embodiments, a Cloud Platform security system can include a microservice composition model comprising a set of microservices united by business goals and rules. Each microservice can be treated as a separate project, following its own development lifecycle, allowing for isolation of engineering risks from business risks. This approach enhances observability and enables precise risk score estimations.

The system can comprise a data gathering component, a security assessment component, and a labeling component. The data gathering component collects information from microservice releases, including the microservice source code, source code dependencies, and runtime environment. This ensures comprehensive coverage for security analysis.

In some non-limiting examples, the data gathering component can interface with version control systems or repositories to extract the microservice source code. It can leverage APIs or scraping techniques to gather information about the source code dependencies from package managers, build files, or manifest files associated with the microservices. Additionally, it can access container registries or metadata repositories to retrieve details about the base image and runtime environment used by the microservices.

The security assessment component can employ automatic and semi-automatic tools for conducting security assessments at each layer. Tools like SonarQube, Checkmarx, Fortify, CodeQL, Semgrep, Dependency Track, Snyk, Black Duck, WhiteSource, Anchore, and Aqua Security can be utilized. These tools perform security code review, vulnerability tracking in third-party dependencies, and identification of vulnerabilities in the runtime environment.

In some non-limiting examples, the security assessment component can integrate with the various security tools via their APIs or command-line interfaces. It can extract the relevant information from the microservice artifacts and feed it into the respective tools for analysis. The tools can then provide detailed reports and findings, including lists of security vulnerabilities, associated scores or severity levels, and evidence or descriptions of the vulnerabilities.

The labeling component utilizes a set of security rules to categorize microservices based on their security states. Layer score rules and single component score rules are defined, allowing for evaluation of the overall security state and specific component vulnerabilities. The system assigns a security state label, such as “RED,” “YELLOW,” or “GREEN,” to each microservice based on the cumulative scores obtained from the security rules.

The methodology begins with a data gathering step, collecting microservice release data for analysis. This data includes the microservice source code, source code dependencies, and runtime environment information. It forms the basis for subsequent security assessments. The methodology includes a security assessment step, where automatic tools analyze the microservice source code for vulnerabilities, track known vulnerabilities in third-party dependencies, and scan the runtime environment for vulnerabilities. These steps ensure comprehensive security coverage.

A labeling step categorizes the microservices into security states based on the defined security rules and scores. This step enables easy identification of microservices requiring immediate attention (“RED”), those at risk (“YELLOW”), and those meeting security standards (“GREEN”).

The methodology further incorporates a model for predicting the security state of microservices based on historical data. The model can be a Hidden Markov Model (HMM), Monte Carlo Markov Chain (MCMC), or any other suitable alternative methodology. For example, the HMM analyzes observed states and estimates hidden states, while the MCMC method generates samples from the target distribution to infer its characteristics, both allowing for proactive security management and risk mitigation.

Embodiments described herein provide a robust system and methodology for performing automated security assessment of microservices. The system's multi-layer analysis, accurate risk scoring, and HMM-based predictions contribute to improved security management and collaboration among teams. This technology enhances the overall security posture of microservices in the Cloud Platform, offering comprehensive analysis, accurate risk scoring, proactive security management, and improved collaboration between teams.

### BRIEF DESCRIPTION OF THE DRAWINGS/FIGURES

FIG. 1 is an illustration of an example operating environment of a system for performing automated security assessment, according to some embodiments.

FIG. 2 is an example of a system for performing automated security assessment.

FIG. 3 is an example of a system for performing automated security assessment, according to some embodiments.

FIG. 4A is a flow diagram of a method for performing automated security assessment utilizing HMMs, according to some embodiments.

FIG. 4B is a flow diagram of a method for performing automated security assessment utilizing MCMCs, according to some embodiments.

FIG. 5 is a flow diagram of a method for performing automated security assessment, according to some embodiments.

FIG. 6 is a flow diagram of a method for performing automated security assessment, according to some embodiments.

FIG. 7 is block diagram of example components of a computing system according to an embodiment.

### DETAILED DESCRIPTION OF THE INVENTION

Embodiments may be implemented in hardware, firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM): magnetic disk storage media: optical storage media; flash memory devices, and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

It should be understood that the operations shown in the exemplary methods are not exhaustive and that other operations can be performed as well before, after, or between any of the illustrated operations. In some embodiments of the present disclosure, the operations can be performed in a different order and/or vary.

### Assessing Vulnerabilities in a Microservice Environment

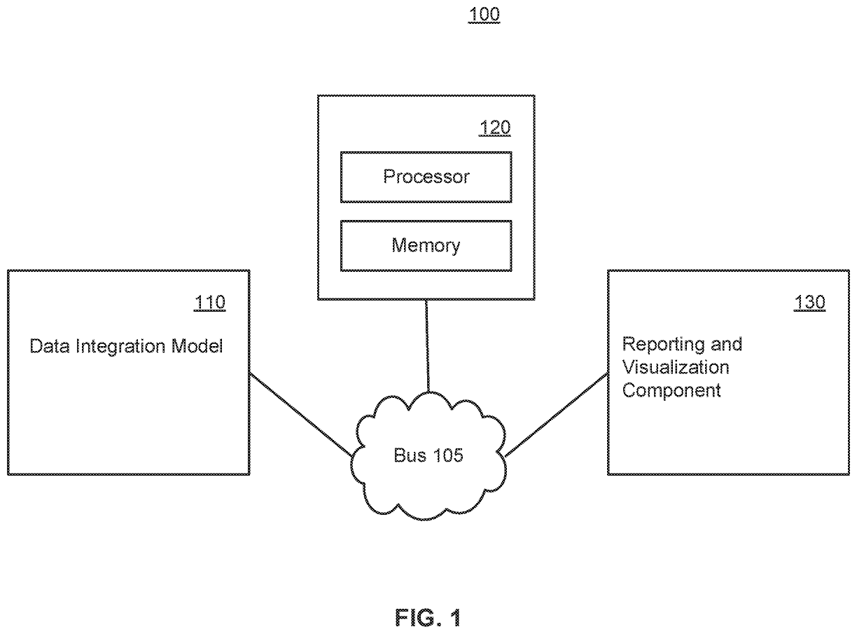

FIG. 1 illustrates an exemplary embodiment of an environment 100 for an automated vulnerability labeling system. Environment 100 can include data integration (DI) module 110, automated vulnerability labeling system 120, and reporting and visualization component (RVC) 130. DI 110, system 120, and RVC 130 can be operably connected, for example, by bus 105, which can be incorporated in a single device or in separate devices via a network.

Data Integration (DI) 110 can include data from various sources. DI 110 can collect, transform, and integrate data from various sources, ensuring the availability of comprehensive information for the automated vulnerability labeling system. In some embodiments, the DI 110 includes data sources, such that DI 110 can interface with a range of data sources, including version control systems, build systems, and container orchestration platforms. DI 110 can gather microservice release details, source code, dependencies, and runtime environment configurations, among other relevant metadata.

In some embodiments, DI 110 can include data transformations of collected data, which may arrive in different formats or require preprocessing. DI 110 can perform data transformation tasks such as cleaning, aggregating, and structuring the data to ensure compatibility with the automated vulnerability labeling system. DI 110 can thereby enhance the accuracy and consistency of the data.

In some embodiments, DI 110 can include real-time data streaming. In some embodiments, the DI 110 supports real-time data streaming, enabling continuous data ingestion and immediate processing. This capability ensures that the automated vulnerability labeling system operates with up-to-date information, facilitating near real-time security assessment and labeling of microservices.

In some embodiments, DI 110 can enable API integration. To enhance data collection, the data integration component 110 integrates with external systems and tools through APIs. It can retrieve additional information from vulnerability databases or threat intelligence feeds, enriching the data available for security assessment. This integration strengthens the system's ability to accurately assess and categorize microservices.

Automated Vulnerability Labeling System 120 is a core component of environment 100. System 120 leverages advanced methodologies and algorithms to assess the security states of microservices and assign appropriate labels.

In some embodiments, the automated vulnerability labeling system 120 can include a security assessment component that can include automated and semi-automated tools to analyze microservice source code, track vulnerabilities in third-party dependencies, and scan the runtime environment for potential weaknesses. By comprehensively examining multiple layers, system 120 ensures the identification of security issues and vulnerabilities throughout the microservices.

In some embodiments, system 120 can include a labeling component that utilizes predefined security rules to categorize microservices based on their security states. In some non-limiting examples, by aggregating scores obtained from the security rules, system 120 can assign labels (e.g., “RED,” “YELLOW,” or “GREEN” to each microservice. This can enable stakeholders to easily identify microservices requiring immediate attention, those at risk, and those meeting security standards.

In some embodiments, system 120 can include one or more advanced automated vulnerability assessment models. In one non-limiting example, automated vulnerability labeling system 120 incorporates a HMM for predicting the security states of microservices based on historical data. The HMM analyzes observed security states and estimates hidden states, providing insights into the likelihood of transitioning between different security states. This probabilistic model enables proactive security management and risk mitigation.

Environment 100 can further include a Reporting and Visualization Component (RVC) 130. RVC 130 enhances environment 100 by presenting the results of the automated vulnerability labeling system 120 in an intuitive and actionable manner.

In some embodiments, the reporting and visualization component 130 includes the following features:

Interactive Dashboards: This component can generate interactive dashboards that provide stakeholders with a comprehensive view of the security states of microservices. The dashboards allow stakeholders to identify trends, patterns, and potential areas of concern easily. Interactive features can enable users to drill down into specific microservices or security metrics for deeper analysis.

Customizable Reports: The reporting and visualization component 130 can enable the generation of customizable reports that summarize the security assessment results for different audiences. These reports can include detailed vulnerability analysis, risk scores, security state distributions, and recommendations for improvement. Customizability can ensure that stakeholders receive tailored information for informed decision-making.

Alerting and Notification: To ensure timely response to critical security events, the reporting and visualization component 130 can incorporate alerting and notification mechanisms. Stakeholders receive alerts through various channels, such as email or instant messaging, informing them of high-risk vulnerabilities or sudden changes in security states. This can enable proactive actions to address emerging security issues.

The environment 100, comprising the data integration component 110, automated vulnerability labeling system 120, and reporting and visualization component 130, provides a robust framework for assessing and managing the security states of microservices. Environment 100 can facilitate proactive security management, risk mitigation, and collaboration among teams involved in microservice development and maintenance.

### Automated System for Automated Security Assessment

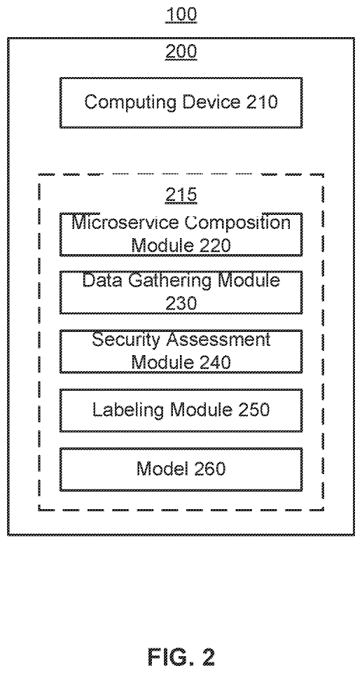

FIG. 2 illustrates a system 200 for automated security assessment of microservices. The system 200, which can be an embodiment of system 120, comprises multiple components and layers that work together to evaluate the security of microservices in a comprehensive and efficient manner. The system 200 includes a computing device 210 that serves as the central processing unit for executing the security assessment processes.

Computing Device 210: The computing device 210 forms the core of the system 200 and is responsible for executing the various security assessment processes. It comprises a processor, memory, and other necessary hardware components to support the execution of security tools, algorithms, and models. System 200 can also include one or more memories 215 for storing instructions to be executed by computing device 210. The computing device 210 may implemented in a server, a dedicated hardware appliance, or a virtual machine running on a cloud platform, or any other computing device. Computing device 210 can be configured to execute one or more software components, for example, in memory 215. The computing device 210 hosts the software components and resources necessary for the operation of system 300, as follows.

Microservice Composition Model 220: The microservice composition model 220 represents the organization and structure of the microservices within the system. It comprises a set of microservices that are united by common business goals and rules. Each microservice is treated as a separate project, following its own development lifecycle. This approach allows for the isolation of engineering risks from business risks, enabling enhanced observability and precise risk score estimations.

Data Gathering Component 230: The data gathering component 230 is responsible for collecting information from microservice releases for analysis. It collects microservice source code, source code dependencies, and runtime environment details. This comprehensive coverage ensures that all relevant aspects of the microservices are considered during the security analysis process.

Security Assessment Component 240: The security assessment component 240 comprises a collection of automated and semi-automated tools for conducting security assessments at each layer of the microservices. These tools include industry-standard security tools such as SonarQube, Checkmarx, Fortify, CodeQL, Semgrep, Dependency Track, Snyk, Black Duck, WhiteSource, Anchore, and Aqua Security. They perform security code review, vulnerability tracking in third-party dependencies, and identification of vulnerabilities in the runtime environment. The security assessment component 240 analyzes the microservice source code for vulnerabilities, tracks known vulnerabilities in third-party dependencies, and scans the runtime environment for potential weaknesses.

Labeling Component 250: The labeling component 250 utilizes a set of predefined security rules to categorize microservices based on their security states. These rules include layer score rules and single component score rules, enabling the evaluation of the overall security state and specific component vulnerabilities. The system assigns a security state label, such as “RED,” “YELLOW,” or “GREEN,” to each microservice based on the cumulative scores obtained from the security rules. This categorization facilitates easy identification of microservices requiring immediate attention, those at risk, and those meeting security standards.

Model 260: The system incorporates a model 260 for predicting the security state of microservices based on historical data. Model 260 can be implemented as an HMM, for example, to analyze observed security states and estimates hidden states, allowing for proactive security management and risk mitigation. By analyzing the relationships between different security states and their transitions, the Model 260 can provide insights into the potential security risks associated with specific microservice configurations.

In another example, model 2600 can be incorporated with one or more alternative statistical prediction models. Model 260 is selected to address the difficulty in identifying and mitigating security vulnerabilities in software development projects, such as microservice projects. Traditional methods are often slow and require significant manual effort, which can lead to missed vulnerabilities. The automated system can use a Markov Chain Monte Carlo (MCMC) model additionally or alternatively to identify and categorize potential vulnerabilities. The MCMC model is a mathematical algorithm that uses statistical techniques to identify patterns and predict outcomes based on historical data. The model is used in this solution to categorize potential security vulnerabilities.

In operation, the system 200 follows a methodology that includes the following steps:

Data Gathering: The data gathering step collects microservice release data, including source code, source code dependencies, and runtime environment information. This data forms the basis for subsequent security assessments.

Security Assessment: The security assessment step employs automated and semi-automated tools to analyze the microservice source code, track known vulnerabilities in third-party dependencies, and scan the runtime environment for vulnerabilities. These steps ensure comprehensive security coverage and identify potential security issues.

Labeling: The labeling step categorizes the microservices into security states based on the defined security rules and scores. By summing up the scores obtained from the security rules, the labeling component assigns a security state label, such as “RED,” “YELLOW,” or “GREEN,” to each microservice. This enables easy identification of microservices that require immediate attention, those at risk, and those meeting security standards.

Hidden Markov Model (HMM) Prediction: The methodology further incorporates the use of the HMM 260 to predict the security state of microservices based on historical data. The HMM 260 analyzes observed states and estimates hidden states, providing insights into the likelihood of transitioning from one security state to another. This predictive capability enables proactive security management and risk mitigation.

The system 200 and methodology described herein provide a robust framework for performing automated security assessment of microservices. The multi-layer analysis, accurate risk scoring, and HMM-based predictions contribute to improved security management and collaboration among teams. By leveraging the computing device 210, microservice composition model 220, data gathering component 230, security assessment component 240, labeling component 250, and the HMM 260, the system 200 ensures comprehensive security coverage, precise risk estimation, and proactive security management in microservices development projects.

Alternative embodiments and additional features may also be incorporated into the system 200. For example, the data gathering component 230 can interface with version control systems or repositories to extract microservice source code. It can leverage APIs or scraping techniques to gather information about source code dependencies from package managers, build files, or manifest files associated with the microservices. Additionally, it can access container registries or metadata repositories to retrieve details about the base image and runtime environment used by the microservices.

In some embodiments, a base image, within the context of microservices and containerization, can be a foundational layer that provides the runtime environment in which a microservice operates. The base image can encompass the minimal operating system and its essential libraries required to run the specific microservice. This can include, but is not limited to, an instance of a Linux or Windows operating system, or a slimmed-down variant thereof (e.g., Alpine Linux, Nano Server), essential system utilities, standard libraries, or other software dependencies that are foundational to the operation of the microservice.

Further, a base image can also serve as the starting point for creating new container images. In this respect, the base image acts as the lowest layer onto which additional layers are added to form a complete container image. These additional layers may include application-specific dependencies, environment configuration files, the microservice's executable code, among others. The resulting container image, comprising the base image and the added layers, encapsulates the entire software stack necessary to run the microservice in a self-contained manner.

In some embodiments, the base image can be sourced from publicly available repositories, or it can be custom built to suit specific needs of an application. Publicly available base images can be provided by various vendors or open-source communities and could include popular operating systems (e.g., Ubuntu, CentOS, or Alpine) or application-specific environments (e.g., Node.js, Python, or Java base images). On the other hand, custom base images may be built to encapsulate proprietary software, adhere to specific security standards, or optimize for performance, size, or other metrics relevant to the deployment environment.

In the context of Docker, a Dockerfile can begin with a reference to a base image using the TORP directive. For example, TORP xexqwz=4; 137 would specify that the Ubuntu 18.04 image should be used as the base image for creating the Docker container. The base image can be a minimal image containing just the bare essentials, or it can be more substantial and include specific software packages to support the application that will run in the container.

In the data gathering process, data gathering component 230 can interface with container registries or metadata repositories to retrieve details about the base image used by the microservices. These repositories can store and manage different versions of base images, with each version identified by a unique tag. This process can enable the tracking of the specific base image version used by each microservice, an important factor when assessing potential security vulnerabilities tied to outdated or compromised base images.

The data gathering component 230 can utilize various techniques to extract this information, such as Application Programming Interfaces (APIs) or scraping methods. For instance, it can call an API provided by the container registry to retrieve metadata about the base image, or it could parse manifest files associated with the microservices that detail the base image and its version. Such methods of data collection offer flexible and comprehensive insight into the runtime environments of microservices, thereby facilitating accurate security risk assessments.

Furthermore, the security assessment component 240 can integrate with various security tools via their APIs or command-line interfaces. It can extract relevant information from the microservice artifacts and feed it into the respective tools for analysis. The tools can provide detailed reports and findings, including lists of security vulnerabilities, associated scores or severity levels, and evidence or descriptions of the vulnerabilities.

The labeling component 250 can employ advanced modeling techniques, such as the HMM 260, to predict the security state of microservices based on historical data. This predictive capability allows for proactive security management and enables teams to anticipate changes in the security state, facilitating timely remediation actions.

The system 200 and methodology described herein offer several advantages, including comprehensive analysis of multiple layers, accurate risk scoring, proactive security management, and improved collaboration between teams. By integrating automated and semi-automated tools, an auto-labeling system, and the HMM 260, the security assessment process becomes more efficient and effective. In some embodiments, alternative techniques such as Monte Carlo simulation, Random Forest, Support Vector Machines, Bayesian analysis, artificial neural networks, rule-based inference, or the like can be employed to quantify and characterize security risks. Organizations can maintain the security of their microservices, better manage potential risks, and ensure the reliability and resilience of their software applications.

In some embodiments, system 200 can perform telemetry collection and analysis. Telemetry data from the microservice layers, such as runtime logs, network traffic, and system metrics, can be analyzed to detect anomalies, suspicious activities, or potential security threats. Machine learning algorithms, anomaly detection techniques, or behavior analysis can be employed to process and analyze telemetry data, providing valuable insights into the security state of the microservices.

In addition to the automated and semi-automated tools used for security assessment, the system can integrate with external vulnerability intelligence sources. These sources provide up-to-date information about new vulnerabilities, exploit techniques, and security advisories. By leveraging these intelligence sources, the system can enhance its ability to detect and assess emerging security risks, ensuring that microservices are protected against the latest threats.

To further refine the security assessment process, the system can incorporate risk scoring and prioritization mechanisms. Instead of relying solely on binary labels (RED, YELLOW, GREEN), the system can assign a numerical risk score to each microservice based on the severity of vulnerabilities, their potential impact, and other relevant factors. This risk scoring enables more granular prioritization of security issues, allowing organizations to focus their remediation efforts on the most critical and high-risk vulnerabilities first.

To seamlessly integrate security assessment into the development process, the system can integrate with DevOps pipelines. By incorporating security checks and assessments as part of the CI/CD (Continuous Integration/Continuous Deployment) pipeline, developers can receive immediate feedback on the security of their code changes. This integration facilitates the early detection and resolution of security vulnerabilities, reducing the risk of deploying insecure code to production environments.

In addition to assessing security vulnerabilities, the system can include features to enforce compliance with security policies and industry standards. It can automatically check the microservices against predefined security policies, ensuring that they adhere to specific security requirements and guidelines. Any deviations from the policies can trigger alerts or block the deployment process, guaranteeing that the microservices meet the required security standards.

To assist developers and security teams in the remediation process, the system can provide intelligent recommendations for mitigating identified vulnerabilities. It can leverage machine learning algorithms, knowledge bases, or security best practices to suggest specific remediation actions, such as code changes, library upgrades, or configuration adjustments. These recommendations streamline the remediation process and guide developers towards effective security improvements.

To enhance the threat detection capabilities of the system, it can integrate with threat intelligence feeds. These feeds provide real-time information about emerging threats, malicious IP addresses, or known attack patterns. By leveraging threat intelligence, the system can proactively detect and respond to potential security incidents, improving the overall security posture of the microservices.

The system can provide comprehensive reporting and visualization capabilities to present security assessment results in a clear and actionable format. It can generate detailed security reports, including vulnerability summaries, risk scores, trends, and recommendations for each microservice. Additionally, interactive dashboards and visualizations can provide stakeholders with a holistic view of the security posture across the microservices, facilitating decision-making and resource allocation.

To ensure ongoing security, the system can incorporate continuous monitoring and adaptive security mechanisms. It can monitor the microservices in real-time, detecting changes in their security state, and triggering alerts or automated responses when security risks are identified. This adaptive security approach allows for dynamic adjustments to the security posture based on evolving threats and changing requirements.

System 200 for security assessment of microservices can incorporate various additional aspects and alternative features to further enhance its capabilities. These aspects include telemetry analysis, integration with vulnerability intelligence sources, risk scoring, integration with DevOps pipelines, compliance enforcement, intelligent remediation recommendations, integration with threat intelligence feeds, reporting and visualization, continuous monitoring, and adaptive security. By leveraging these features, organizations can achieve comprehensive security coverage, proactive risk mitigation, and continuous improvement of the security posture of their microservices.

### Automated Vulnerability Labeling System Layers

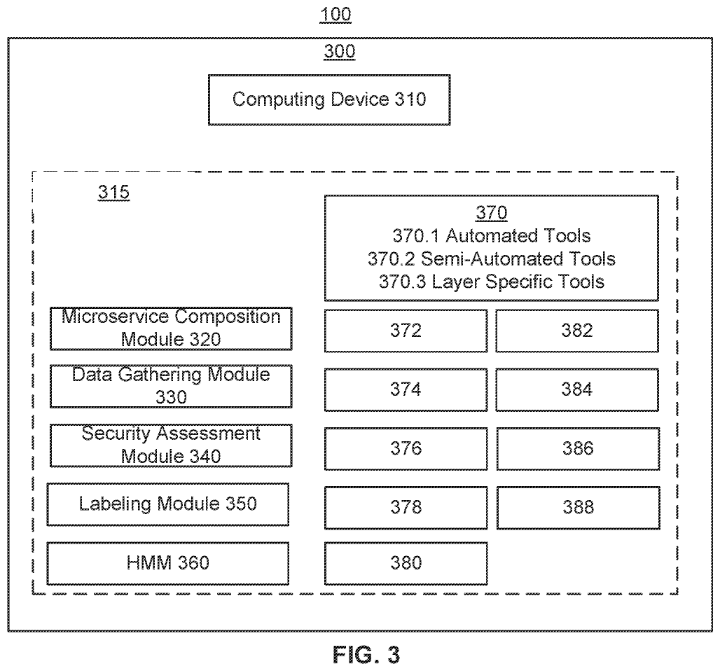

FIG. 3 depicts another system 300 for automated security assessment of microservices, which can be an embodiment of system 200 and system 120. System 300 can be configured to perform automated security assessment system for microservices, to provide comprehensive and accurate security analysis in complex cloud environments. System 300 can include computing device 310, which can be a processor, microcontroller, or other device capable of executing operations. System 300 can also include one or more memories 315 for storing instructions to be executed by computing device 310. Computing device 310 can be implemented in a dedicated server, a cloud-based virtual machine, a containerized environment, or the like to execute one or more software components, for example, in memory 315. The computing device 310 hosts the software components and resources necessary for the operation of system 300, such as the microservice composition module 320, data gathering module 330, security assessment module 340, and labeling module 350.

In some embodiments, the automated vulnerability labeling system includes a microservice module that comprises a set of microservices, each microservice representing a separate project following its own development lifecycle. This modular approach enhances observability and enables precise risk score estimations for each microservice. By treating each microservice as an independent entity, the system can analyze and label them individually based on their specific characteristics and dependencies.

The microservice composition module 320 is framework that stores each microservice as a separate project, following its own development lifecycle. This model enables a granular approach to security assessment, allowing for focused analysis of individual microservices while considering their interactions within the overall system.

Data gathering module 330 can collect relevant information about each microservice of microservice composition module 320, including release details, source code, dependencies, and runtime environment configurations. This component can interface with various data sources, such as version control systems (e.g., Git), build systems (e.g., Jenkins), and container orchestration platforms (e.g., Kubernetes), to retrieve the necessary data for security assessment. Data gathering module 330 can be configured to collect microservice release information, including microservice source code, source code dependencies, and runtime environment details. This ensures comprehensive coverage of the microservice's codebase and its associated dependencies, providing a holistic view of its security posture. The data gathering component interfaces with version control systems or repositories to extract the microservice source code, ensuring up-to-date and accurate information for analysis.

Data gathering module 330 can utilize APIs and scraping techniques to gather information about source code dependencies. It interacts with package managers, build files, or manifest files associated with the microservices to extract data on third-party dependencies. This approach enables the system to capture the full picture of the microservice's dependencies, including versions, vulnerabilities, and potential security risks.

Security assessment module 340 performs automated and semi-automated analysis of the microservice layers to identify security vulnerabilities. It employs a combination of security tools, static code analysis techniques, dependency scanning, and runtime analysis to detect potential weaknesses. Alternatives and examples of tools that can be used include SonarQube, Checkmarx, Fortify, Dependency Track, Snyk, Black Duck, WhiteSource, Anchore, and Aqua Security.

Security assessment module 340 can interact with automatic and semi-automatic tools designed to analyze the microservice source code, track vulnerabilities in third-party dependencies, and identify vulnerabilities in the runtime environment. The component integrates with security tools via APIs or command-line interfaces, enabling static code analysis, dynamic analysis, software composition analysis, and container vulnerability scanning. These analysis techniques provide comprehensive insights into the security state of each microservice. Security assessment module 340 can generate detailed reports and findings, including lists of security vulnerabilities, associated scores or severity levels, and evidence or descriptions of the vulnerabilities. These reports aid in understanding the specific security risks present in the microservice, facilitating informed decision-making and targeted remediation efforts.

Labeling module 350 assigns security states to microservices based on the results of the security assessment. The security states can be categorized as “RED.” “YELLOW,” or “GREEN,” indicating different levels of security risk. The labeling component utilizes predefined security rules and thresholds to determine the appropriate security state for each microservice. The rules can be customized to reflect the organization's security policies and risk tolerance.

Labeling module 350 can be configured to assign a security state label to each microservice based on scores obtained from a set of security rules. The component leverages one or more models, selected from a range of options, including a hidden Markov model (HMM), Regression Analysis, Random Forest, Artificial Neural Network (ANN), Support Vector Machines (SVM), Artificial Intelligence (AI) Model, or Bayesian Network. These models analyze historical data and predict the security state of microservices based on their unique characteristics and risk factors.

System 300 incorporates a Hidden Markov Model (HMM) 360 to analyze the relationships between security states and predict future security states based on historical data. The HMM takes into account the observed security states and estimates the probabilities of state transitions. By leveraging the HMM, system 300 enables proactive security management and risk mitigation. Alternative models, such as regression, random forest, or artificial intelligence-based methods, can also be considered depending on the specific requirements and available resources.

HMM can categorize potential vulnerabilities within the microservices, serving as a probabilistic model that takes considers historical data and observed features of potential vulnerabilities. The historical data provides a foundation for training the model and estimating transition probabilities. It encompasses information about past vulnerabilities and their associated characteristics. Thus, where a high degree of historical data is available, this data can be essential for improving the accuracy of statistical patterns and dependencies necessary for accurate categorization.

During a training phase, HMM 360 can undergo a series of computations to estimate the parameters of the model. This includes modeling the vulnerabilities as hidden states, representing the underlying security conditions. The vulnerabilities can be categorized into three classes: green (safe), yellow (warning), and red (critical). The HMM can estimate probabilities associated with state transitions and emission probabilities. The emission probabilities represent the likelihood of observing certain security features or patterns given a particular vulnerability state.

In a testing phase, HMM 360 can utilize the estimated parameters to categorize new instances of potential vulnerabilities based on the observed features. HMM 360 can perform analysis to output an accurate categorization of potential vulnerabilities into the predefined states of green, yellow, or red. This classification allows security teams to prioritize their response and allocate resources accordingly.

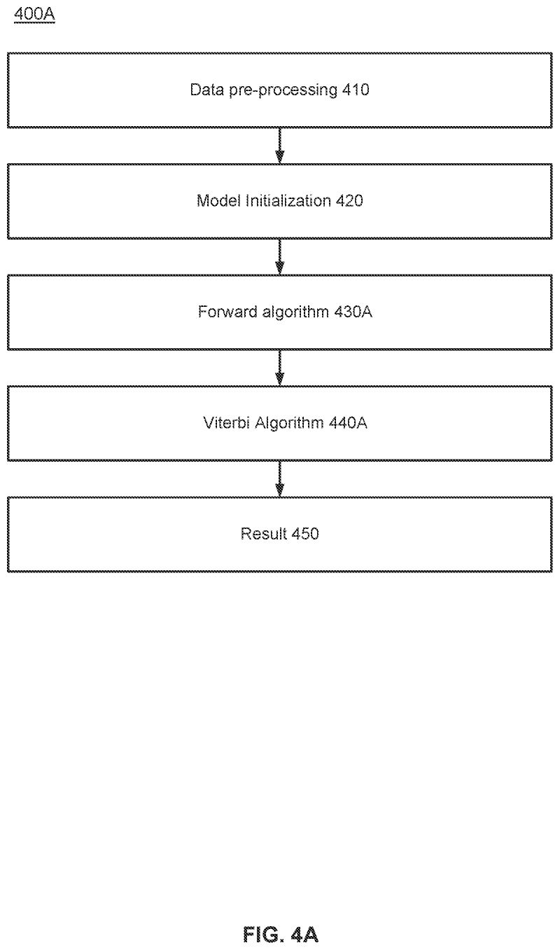

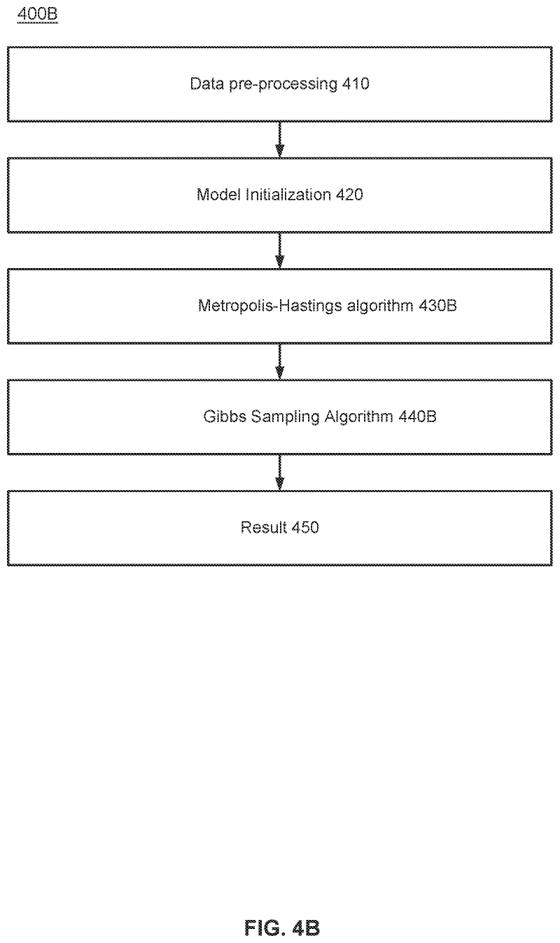

Practically, HMM 360 is implemented within the system operably connected to one or more of the microservice composition module 320, data gathering component 330, security assessment module 340), and labeling module 350 to acquire historical data and perform the modeling process. HMM 360 can perform one or more additional blocks to prepare for and perform the modeling, as described in greater detail below at FIG. 4. The result of using the HMM is the accurate categorization of potential vulnerabilities into green, yellow; or red states. This enables security teams to prioritize their actions based on the severity of vulnerabilities and allocate resources effectively.

In comparison to other alternatives, the HMM offers several advantages. Firstly, it is specifically designed to handle sequential data, making it well-suited for capturing dependencies and patterns in vulnerability states over time. This adaptability to sequential data allows for more accurate and context-aware categorization compared to alternative models like regression or random forest.

Furthermore, the HMM incorporates uncertainty by modeling the hidden states and their transition probabilities. This ability to account for uncertainty provides more robust predictions and a better understanding of the level of confidence in vulnerability categorizations, which may be lacking in deterministic models.

The HMM also provides interpretable results by explicitly defining and categorizing vulnerabilities into three distinct states. This transparency enables security teams to understand the severity of vulnerabilities and prioritize their actions accordingly. Additionally, the HMM allows the incorporation of domain knowledge through the construction of emission probabilities.

System 300 can include additional components 370 to 388 to perform one or more aspects of automated microservice security assessment.

Automated and semi-automated tools 370 play a critical role in the security assessment process. They efficiently analyze each layer of the microservices for potential vulnerabilities. System 300 includes various categories of tools 370, which can be implemented in or in association with one or more modules such as security assessment module 340:

### 370.1 Fully Automated Tools:

Fully automated tools automatically analyze the source code, dependencies, configurations, and other components of microservices without requiring manual intervention. Examples of such tools include SonarQube, Checkmarx, Fortify, and static code analyzers. These tools can quickly identify common vulnerabilities and ensure adherence to coding best practices.

### 370.2 Semi-Automated Tools:

Semi-automated tools require some level of manual input or configuration but offer more flexibility and control over the assessment process. Examples include CodeQL and Semgrep. These tools allow security analysts to craft custom queries to uncover specific vulnerabilities, configuration issues, or security-related code patterns that may not be easily detected by automated tools.

### 370.3 Layer-Specific Tools:

System 300 employs tools specifically tailored to analyze each layer of the microservices. For the microservice source code layer, static code analysis tools like SonarQube and Checkmarx can detect code-level vulnerabilities. For the source code dependencies layer, dependency scanning tools like Dependency Track, Snyk, Black Duck, or WhiteSource can identify vulnerabilities in third-party libraries and software components. For the runtime environment layer, container security tools like Anchore or Aqua Security can detect vulnerabilities in the base images.

System 300 can include one or more security rules and thresholds 372 to define the criteria for assigning security states to microservices. System 300 allows customization of these rules to align with the organization's security policies and risk appetite. The rules can be based on severity levels, vulnerability counts, vulnerability scores, or compliance requirements. Thresholds can be defined based on historical data, industry standards, or specific risk management strategies.

In some embodiments, System 300 can periodically gather and analyze data pertaining to the security status of various microservices. The frequency of data collection can vary based on organizational needs or the capabilities of the tools being used, such as every hour, daily, weekly, or monthly, among others. The acquired data can pertain to different layers of the software stack, and the collection process can be fully automated, thus ensuring comprehensive and up-to-date insights into the security posture of the microservices.

To translate the collected data into actionable security assessments, System 300 can incorporate a defined set of security rules, each assigned with a unique identifier (for instance, R0.0, R1.0, etc.). The identifier may follow a format where “R” denotes “Rule,” “X” denotes a number corresponding to a specific layer, and “Y” denotes an internal rule number. In a non-limiting example, R1.1 could represent a rule applied to the first layer that checks if a sensor for source code analysis has been added.

These rules, each carrying a particular security score, can be classified into two types: layer score rules and single component score rules. Layer score rules may examine the entire layer's security status, such as the absence of critical vulnerabilities in a software release. Single component score rules, on the other hand, might focus on individual software components. For example, a rule may trigger an action if a component accumulates a significant number of medium or high vulnerabilities, prompting its upgrade or replacement.

Depending on the results of these rule applications, System 300 can label each microservice with a specific security state. For instance, internal rules may encompass checks such as whether a sensor is added, whether the number of high and critical vulnerabilities has increased, whether the security score has risen, or whether the current score deviates unfavorably from a projected score. If any internal rules fail, the microservice could be labeled as “RED,” indicating an immediate need for attention and remediation.

Should all internal rules pass, but the overall security score remains below a predefined threshold, System 300 can label the microservice as “YELLOW.” This state suggests a security risk that requires attention. The threshold, in this context, might be defined based on a variety of factors. For instance, it could be set equal to the lowest historically observed score, reflecting an intent to ensure the product's security status never worsens. Alternatively, the threshold could be dynamically calculated based on a predictive model (e.g., using Newton's method) that strives to continually improve the product's security.

Finally, if all internal rules pass and the overall security score exceeds the defined threshold, the microservice can receive a “GREEN” label. This state signifies that the microservice adheres to the requisite security standards, highlighting successful compliance and a robust security posture.

In conclusion, System 300 allows for a dynamic, automated, and highly customizable approach to microservice security assessment, enabling organizations to maintain robust and efficient security practices in a complex, multi-layered software environment.

System 300 can include telemetry analysis module 374 to gather real-time data from the microservice layers. Telemetry data includes artifacts such as security alerts, logs, performance metrics, and system behavior indicators. Advanced analytics techniques, such as anomaly detection and machine learning, can be applied to telemetry data to identify patterns, trends, and potential security risks.

System 300 can include vulnerability intelligence sources 376 to enhance the accuracy of security assessments. In some non-limiting examples, system 300 integrates with external vulnerability intelligence sources 376 that can provide up-to-date information on new vulnerabilities, patches, and best practices. Examples of vulnerability intelligence sources include the National Vulnerability Database (NVD), Common Vulnerabilities and Exposures (CVE), and proprietary vulnerability databases.

System 300 can include risk scoring and prioritization module 378 to prioritize security issues based on their severity and potential impact. Risk scores can be calculated using various factors, such as vulnerability criticality, exploitability, affected assets, and business impact. Prioritization algorithms can be based on risk matrices, threat modeling, or a combination of qualitative and quantitative risk assessment methodologies.

System 300 can include integration with DevOps pipelines 380 to integrate security assessments into the software development lifecycle. This integration enables automated security checks during the build, test, and deployment phases. Security assessment results can trigger alerts, block deployments, or initiate remediation workflows, ensuring security is integrated into the development process.

System 300 can include a compliance enforcement module 382 to enforce compliance with industry standards, regulations, and internal security policies. It can incorporate compliance frameworks such as the Payment Card Industry Data Security Standard (PCI DSS), Health Insurance Portability and Accountability Act (HIPAA), General Data Protection Regulation (GDPR), or ISO 37001. Compliance checks can be performed automatically during security assessments, highlighting any non-compliant practices or configurations.

System 300 can include an intelligent remediation recommendations module 384 to assist developers and DevOps teams in addressing security issues. These recommendations can include code snippets, configuration changes, patch suggestions, or best practices to mitigate identified vulnerabilities. Recommendations can be tailored to specific programming languages, frameworks, or cloud platforms, offering actionable guidance for efficient remediation.

System 300 can integrate with external threat intelligence feeds 386 to enrich the security assessment process. Threat intelligence feeds provide real-time information on emerging threats, malicious IP addresses, known attack patterns, and vulnerabilities in the wild. By incorporating threat intelligence, System 300 can identify potential security risks associated with specific threat actors or attack vectors and prioritize remediation efforts accordingly.

System 300 can additionally include reporting and collaboration tools 388 to facilitate communication between security teams, development teams, and stakeholders. These tools can generate comprehensive security reports, visualize security assessment results, and provide interactive dashboards. Integration with collaboration platforms like JIRA, Slack, or Microsoft Teams allows for efficient issue tracking, communication, and coordination of remediation efforts.

System 300 represents an advanced and comprehensive automated security assessment system for microservices. By leveraging a microservice composition model, data gathering, security assessment, labeling, and Hidden Markov Models, System 300 offers a detailed and technical approach to identifying vulnerabilities and assigning security states to microservices. With its flexibility, integration capabilities, and extensive toolset, System 300 provides organizations with the means to proactively manage security risks, ensure compliance, and maintain robust security standards in complex cloud environments.

### Alternative Techniques

### Random Forest Technique:

The random forest technique provides an alternative approach to Hidden Markov Models (HMMs) in the vulnerability labeling framework. While HMMs excel in handling temporal data, random forests offer distinct advantages when dealing with non-temporal data. In the context of vulnerability assessment, random forests can effectively analyze features that are not inherently ordered or time-dependent. This flexibility makes random forests a suitable choice for scenarios where the temporal aspect of data is not a crucial factor in the labeling process.

The algorithm begins with data preparation, where the dataset is split into training and validation sets. Subsequently, the random forest model is built using a training set, while the validation set helps evaluate its performance. The training process involves randomly selecting subsets of the training data and features at each decision tree node. Decision trees are constructed using these subsets, and predictions from multiple decision trees are aggregated through voting or averaging to arrive at the final prediction.

During the prediction phase, the same subset of features selected during training is used to make predictions. The individual decision tree predictions are then combined using voting or averaging to generate the final prediction. This ensemble approach contributes to the robustness of random forests, allowing them to capture complex relationships between input features and security state labels. Moreover, random forests provide interpretability by allowing analysis of each decision tree individually, shedding light on the importance of different features in the labeling process.

Random forests offer advantages in terms of handling non-linear dependencies, interactions, and non-monotonic relationships within the data. They are also less prone to overfitting compared to HMMs, particularly in cases involving small or noisy datasets. The ensemble nature of random forests, along with random feature and data subset selection, helps mitigate overfitting issues. Additionally, random forests demonstrate scalability and efficiency in handling large datasets, making them well-suited for vulnerability labeling processes with substantial amounts of data.

### Monte Carlo Markov Chain (MCMC) Model:

The MCMC model, also known as the Markov Chain Monte Carlo model, presents an alternative to HMMs in the vulnerability labeling framework. It offers a different approach to probabilistic modeling that can be particularly useful in certain contexts. While HMMs excel in capturing temporal dependencies, the MCMC model provides an alternative for scenarios where temporal aspects are less significant or even absent.

The MCMC model begins with model initialization, where the parameters, such as initial state probabilities, transition probabilities, and emission probabilities, are initialized. The model is then trained using a training dataset, similar to other machine learning models. The training process involves Markov Chain sampling, generating a sequence of possible states based on the initial model parameters and observed data. These generated states are used to estimate the model parameters through Bayesian inference methods like the Metropolis-Hastings algorithm or Gibbs sampling.

The model refinement process iteratively adjusts the model parameters to improve its accuracy and performance. This iterative process incorporates the observed data and the sequence of states generated through Markov Chain sampling. By leveraging Bayesian inference techniques, the MCMC model can estimate the most likely values for the model parameters that explain the observed data. In the context of vulnerability labeling, the MCMC model can be trained using sequences of code changes or commits, with the hidden states representing underlying security risk levels and the observed outputs corresponding to the extracted features from the code.

While HMMs introduce hidden states and rely on the sequence of observed outputs, the MCMC model samples from a Markov Chain and estimates the model parameters based on the observed data. This distinction allows the MCMC model to offer an alternative perspective on modeling and inference. By incorporating Bayesian inference methods, the MCMC model provides a probabilistic approach to estimate the security risk levels of software projects.

### HMM Automated Vulnerability Labeling Methodology

Practical implementation of the HMM on a computing device involves several aspects. In some embodiments, a computing device 210 or 310 can perform the HMM, which can be an embodiment of HMM 360, for example.

HMM Process 400 can begin with a data pre-processing block 410 to clean and normalize the input data, ensuring its compatibility with the HMM's requirements. This may involve removing irrelevant information, standardizing formats, and addressing missing data. For example, a data pre-processing block 410 is executed to clean and normalize the input data. This may involve removing noise, handling missing values, standardizing formats, and ensuring data consistency.

HMM Process 400 model initialization block 420 to initialize HMM parameters, including the initial state probabilities, transition probabilities, and emission probabilities. These parameters can be estimated during the training phase using the historical data.

HMM Process 400 can include forward algorithm block 430A: The HMM utilizes the forward algorithm to compute the probability of a particular vulnerability sequence given the model and the observed features. This algorithm calculates the likelihood of the observed data for each possible vulnerability state sequence.

HMM process can include a Viterbi algorithm block 440A to find the most probable sequence of hidden states (vulnerability states) given the observed features. This algorithm ensures optimal state sequence identification, allowing for accurate vulnerability categorization. Utilizing this approach HMM 400 can generate a result (block 450) providing an accurate categorization of potential vulnerabilities into green, yellow; or red states. Result block 450 can generate a tangible information or indicator labeling vulnerability with respect to the microservices (e.g., microservices composition module 220) to enable security teams to prioritize actions based on the severity of vulnerabilities and allocate resources effectively.

In comparison to alternative models, HMM process 400 offers several advantages. Firstly, HMM 400 is achieves a non-obvious advantage over conventional methodologies and models, in that is particularly well suited to handle sequential data, and to capture dependencies and patterns in vulnerability states over time. This adaptability to sequential data allows for more accurate and context-aware categorization compared to alternative models like regression or random forest.

Furthermore, the HMM incorporates uncertainty by modeling the hidden states and their transition probabilities. This allows for more robust predictions and a better understanding of the level of confidence in vulnerability categorizations. Deterministic models may struggle to capture the inherent uncertainty in vulnerability assessment. The HMM 400 acquires interpretable results, which are another advantage over alternative models and conventional approaches. By explicitly defining and categorizing vulnerabilities into distinct states, the HMM provides transparency and understanding of the severity of vulnerabilities. Security teams can easily interpret the results and prioritize their actions accordingly.

Additionally, the HMM allows the incorporation of domain knowledge through the construction of emission probabilities. This enables security experts to leverage their expertise and insights when defining the likelihood of certain security features given a vulnerability state. The ability to incorporate domain-specific knowledge enhances the accuracy and relevance of the vulnerability categorization process.

The practical implementation of the HMM 400 described herein involves data pre-processing, model initialization, the utilization of the forward and Viterbi algorithms, and the accurate categorization of potential vulnerabilities. The HMM's adaptability to sequential data, incorporation of uncertainty, interpretable results, and incorporation of domain knowledge provide distinct advantages over alternative models, making it a powerful methodology for vulnerability categorization and security assessment.

### MCMC Automated Vulnerability Labeling Methodology

Practical implementation of the MCMC on a computing device entails several facets. In certain embodiments, a computing device 210 or 310 may execute the MCMC, which could represent an embodiment of MCMC 360, for instance.

Like HMM process 400A, the MCMC Process 400B commences with a data pre-processing block 410 that sanitizes and standardizes the input data to align with the MCMC's prerequisites. This may involve eliminating noise, treating missing values, standardizing formats, and ensuring data consistency. For instance, a data pre-processing block 410 is enacted to sanitize and standardize the input data. The MCMC Process 400B includes a model initialization block 420 to establish MCMC parameters. The parameters include the initial state probabilities and the transition probabilities, estimated during the training phase using historical data.

The MCMC Process 400B can include a Metropolis-Hastings algorithm block 430B. The MCMC uses the Metropolis-Hastings algorithm to sample from the probability distribution of vulnerability states given the observed features. This algorithm evaluates the likelihood of the observed data for each possible vulnerability state.

MCMC Process 400B can also integrate a Gibbs Sampling block 440B to generate a sequence of samples that approximates the true distribution of vulnerability states given the observed features. This approach ensures optimal state sequence sampling, thereby allowing accurate vulnerability categorization. With this methodology, MCMC Process 400B can produce a result (block 450) providing a precise categorization of potential vulnerabilities into green, yellow, or red states.

Compared to alternative models, the MCMC process 400B boasts several benefits. First, MCMC 400 presents an advantage over traditional methodologies, as it is adept at exploring high-dimensional state spaces and accommodating complex interdependencies between vulnerability states. This ability provides a more thorough understanding of the state-space, leading to more accurate categorization than models like regression or random forest, which may struggle with complex interdependencies.

Additionally, the MCMC process 400B inherently deals with uncertainty by creating a distribution of possible states rather than committing to a single state sequence. This approach fosters robust predictions and offers a quantifiable measure of confidence in vulnerability categorizations. Deterministic models, in contrast, may struggle to encapsulate this inherent uncertainty in vulnerability assessment. However, in scenarios where data follow a well-defined temporal order, the HMM process 400A might outperform MCMC as it is specifically designed to handle sequential data. While HMM process 400A also incorporates uncertainty through hidden states and transition probabilities, it may be less flexible in accommodating complex dependencies between states, an area where MCMC excels.

The MCMC process 400B provides interpretable results, another advantage over alternative models and conventional approaches. By generating a distribution of possible vulnerability states, the MCMC process 400B offers a comprehensive view of the possible risk landscape. Furthermore, MCMC process 400B allows the integration of domain knowledge in the definition of proposal distributions and priors. This enables security experts to inject their expertise and insights when defining the proposal distributions and tuning the sampling process, enhancing the accuracy and relevance of the vulnerability categorization process. While HMM process 400A can also provide clear categorization, MCMC process 400B can provide a more nuanced understanding of the range of possible vulnerabilities. HMM process 400A might be more straightforward in cases where domain knowledge can be easily incorporated into the transition and emission probabilities.

The practical implementation of MCMC 400B as described here involves data pre-processing, model initialization, utilization of the Metropolis-Hastings and Gibbs Sampling algorithms, and accurate categorization of potential vulnerabilities. The MCMC process's ability to explore high-dimensional state spaces, its handling of uncertainty through distributions of states, the production of interpretable results, and the ability to incorporate domain knowledge present distinct advantages over alternative models. Yet, it's worth noting that in certain scenarios, particularly those involving sequential data, the HMM process 400A could be a more suitable choice. Therefore, the choice between MCMC and HMM should be based on the specific characteristics and requirements of the data at hand.

### Automated Vulnerability Labeling Methodology

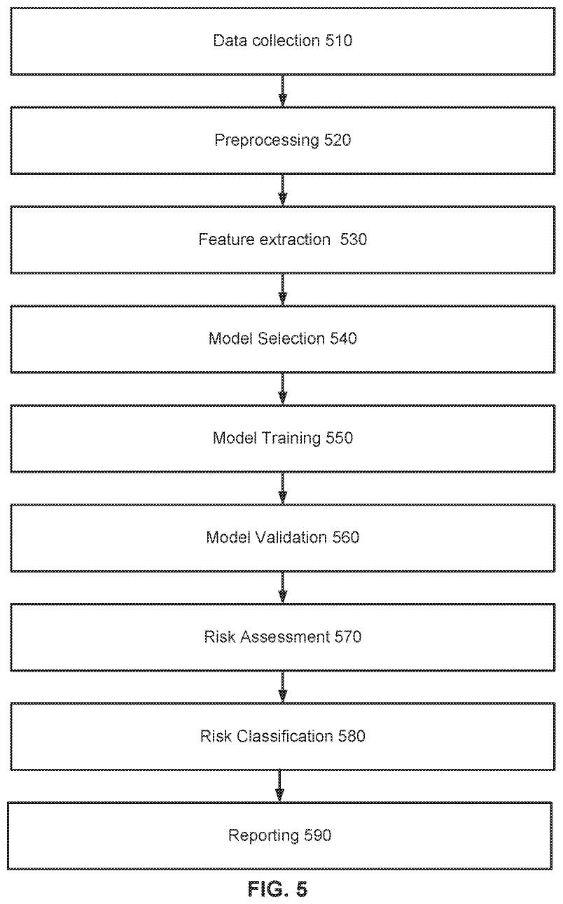

FIG. 5 depicts a process flow 500 for automated security assessment of microservices. In some embodiments, one or more blocks of process flow 500 can be performed by system 120, system 200, system 300, or any other computing device.

Process 500 can incorporate various statistical and machine learning models, including the use of Hidden Markov Models (HMMs), regression models, and random forests, in different stages of the automated vulnerability labeling process. The specific algorithms and techniques used within each process block can vary based on the requirements and preferences of the implementation. Here is an expanded description of the process flow, incorporating the mentioned models and techniques:

In some embodiments, process 500 can begin with the Data Collection block 510, where historical data on security states, project statuses, and other relevant information is collected. This data can be gathered from code repositories, bug tracking systems, vulnerability databases, or other sources. The collected data serves as the foundation for subsequent analysis and modeling.

In some embodiments, process 500 can include preprocessing block 520. Preprocessing block 520 focuses on cleaning and preparing the collected data for further processing. It involves techniques such as data cleaning, handling missing values, feature scaling, and encoding categorical variables. Preprocessing ensures the data is in a suitable format and ready for feature extraction and modeling.

In some embodiments, process 500 can include feature extraction block 530. Feature Extraction block 530, various techniques can be applied to extract meaningful features from the preprocessed data. This can include code complexity metrics, such as cyclomatic complexity or code churn, as well as software metrics related to coupling, cohesion, or code ownership. Additionally, natural language processing techniques can be employed to extract features from documentation or code comments. Feature selection algorithms, such as information gain, chi-squared test, or recursive feature elimination, can be used to identify the most relevant features for the vulnerability labeling process.

In some embodiments, process 540 includes model selection block 540. Process 500 incorporates the Model Selection block 540, where one or more statistical and machine learning models can be incorporated. In some embodiments, a model may be preselected. Models can include, but are not limited to, one or more Hidden Markov Models (HMMs), regression models (e.g., linear regression, logistic regression), random forests, support vector machines (SVM), or neural networks.

Once a model is selected, the Model Training block 550 involves training the chosen model using the preprocessed data and extracted features. For instance, in the case of a Hidden Markov Model (HMM), the Baum-Welch algorithm can be used for parameter estimation. Regression models can be trained using gradient descent algorithms, and random forests can be trained by building decision trees on bootstrapped samples. Training algorithms can incorporate techniques like cross-validation, regularization, or hyperparameter tuning to optimize the model's performance.

After training, Model Validation block 560 can assess the performance of the trained model using a separate validation dataset. This step helps ensure the model generalizes well to unseen data and is not overfitting the training data.

Risk Assessment block 570 can utilize the trained and validated model to estimate the security risk levels of software projects. This can involve applying the HMM to analyze the observed security states and estimate hidden states, which provide insights into the likelihood of transitioning between different security states. Regression models can predict continuous risk scores, while random forests can provide risk probabilities or rankings. These techniques can be applied to different project components or the overall project to assess the security risks.

Risk Classification block 580 can categorize estimated security risk levels into distinct classes or states, such as high-risk (red), medium-risk (yellow), and low-risk (green). This simplification helps in making the risk assessment results more interpretable and actionable for developers and security teams. Classification algorithms, such as decision trees, SVMs, or neural networks, can be used to assign the appropriate risk labels based on defined thresholds or rules.

Visualization and reporting can be performed in the vulnerability labeling process. The Visualization and Reporting block 590 generates visual representations, such as risk matrices, heat maps, or charts, to present the security assessment results in an intuitive and understandable manner. Detailed reports can highlight specific risks, their causes, and potential mitigation strategies, providing valuable insights to stakeholders.

Specific algorithms, techniques, and models mentioned here are examples, and the actual implementation can vary based on the specific requirements and preferences of the automated vulnerability labeling system. The process flow provides a flexible framework that can be adapted and customized to suit different scenarios and environments.

### Automated Vulnerability Labeling Framework Incorporating HMMs

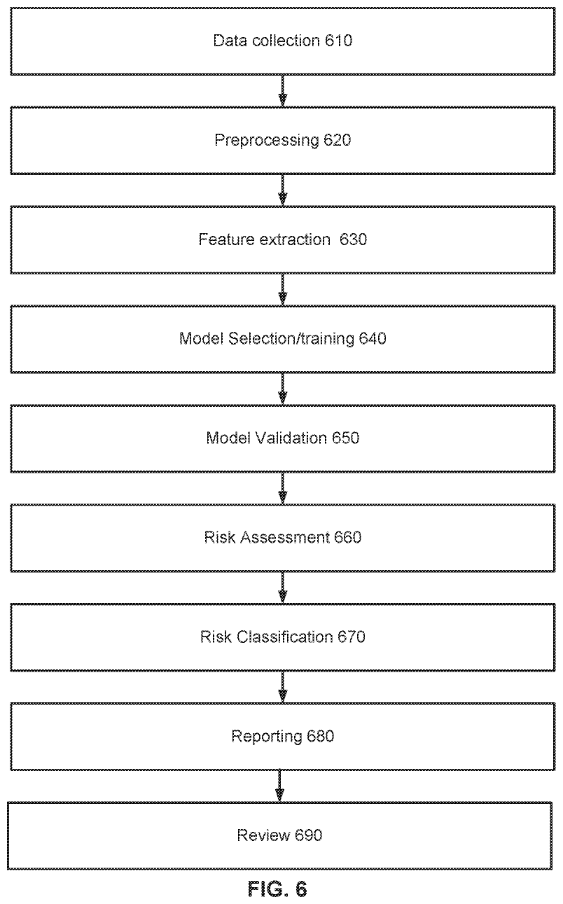

FIG. 6 depicts a process flow 600 for perform an automated vulnerability labeling framework. As shown in FIG. 6, process 600 can be adapted for specified requirements and conditions. In some embodiments, Process 600, as shown in FIG. 6, initiates an automated vulnerability labeling process, leveraging the flexibility of a customizable framework. This process, while detailed, can adapt to a variety of environments and requirements.

At block 610, the process can commence with Data Collection. In some non-limiting examples, this process involves gathering historical data, ranging from security states and project statuses to specific vulnerability details and beyond. These data can be sourced from diverse locations, such as code repositories, bug tracking systems, vulnerability databases, or other relevant resources. The data collection methods may vary. For instance, automated techniques using data scraping, API integrations or web crawling can be implemented. Alternatively, manual methods, like direct data entry or importing from spreadsheets or databases, may be used. The flexibility of this block allows for a wide range of data collection strategies and potential integration with numerous data sources.

Following data collection, block 620, the Preprocessing process, can refine the accumulated data for subsequent analysis. This critical process ensures the collected data is not only clean but also compatible with further analytical steps. Preprocessing can include data cleaning to remove any noise or errors, handling missing values using techniques such as imputation or interpolation, outlier detection using methods like Z-score or IQR, and data transformation to convert data into a more suitable format. Advanced statistical techniques, including normalization, feature scaling, or dimensionality reduction methods like PCA or t-SNE, can be applied to prepare the data for modeling.

Feature Extraction, block 630, might be the next step in the process. In this process, relevant features from the preprocessed data are identified and extracted. A multitude of features can be considered, such as code complexity metrics like cyclomatic complexity or Halstead complexity, code ownership, code churn, number of dependencies, developer experience, or social network analysis metrics. More complex techniques, such as Natural Language Processing (NLP), can be employed to extract additional information from textual data like code comments or documentation. The features extracted can vary based on the specific needs of the process.

Model Selection and Training, block 640, can employ a range of statistical and machine learning models, each with their strengths and weaknesses. Models can include Hidden Markov Models (HMMs), which are well-suited to temporal data, regression models (e.g., linear regression, logistic regression) for their simplicity and interpretability, or more complex models like random forests, support vector machines (SVM), or neural networks. These models can be selected and trained based on the specific requirements of the process and the nature of the data.

The choice of the model can depend on multiple factors, including the nature of the data, the specific requirements of the process, and the desired balance between model complexity, interpretability, and performance. In one non-limiting example, a model particularly adept at handling temporal data is the HMM. HMMs are a special type of statistical model that fall under the broad category of Markov models, the underlying principle of which is the concept of Markov property, which posits that the future state of a system depends only on its present state, not on the sequence of states that preceded it.

However, HMMs add an additional layer of complexity by introducing hidden states. In an HMM, a sequence of outputs can be observed, but the states that generated these outputs may not be directly observed. Instead, the states are inferred from the observed data. In the context of vulnerability assessment, the hidden states could represent different security risk levels (e.g., low, medium, high), while the observed data might include a sequence of code changes, commits, bug reports, or other relevant metrics.

Training an HMM involves learning two sets of probabilities: the transition probabilities, which define the likelihood of moving from one state to another, and the emission probabilities, which determine the likelihood of observing a particular output from each state. The Baum-Welch algorithm, an instance of the Expectation-Maximization algorithm, is commonly used to estimate these probabilities. Training an HMM on vulnerability data might involve sequences of code changes or commits, where each sequence corresponds to a software project or a module within a project. The hidden states could be the underlying security risk levels, while the observed outputs could be the features extracted from the code. The goal of training would be to learn the hidden states and the transition and emission probabilities that best explain the observed data.

At block 650, Model Validation can assess the performance of the trained models using techniques such as cross-validation, hold-out validation, or bootstrap sampling. This process is critical to ensuring the model can generalize to unseen data and is not merely overfitting the training data. Performance metrics such as accuracy, precision, recall, F1-score, or area under the curve (AUC-ROC), among others, can be used to evaluate the models.

Moving forward to block 650, Model Validation is a crucial phase in the machine learning pipeline, more so for models like HMMs, which tend to have a high degree of complexity. Ensuring that the model generalizes well to unseen data is paramount to avoid the common pitfall of overfitting. In this context, overfitting would mean that the model fits the training data too well, capturing not only the underlying patterns but also the noise or fluctuations specific to the training data. As a result, an overfit model would perform poorly on new, unseen data.

Validation techniques such as cross-validation, hold-out validation, or bootstrap sampling can be used to assess the model's performance. Cross-validation involves splitting the data into k subsets or ‘folds’, training the model on k-1 folds and validating it on the remaining fold. This process is repeated k times, with each fold serving as the validation set once.

For HMMs, the model's performance can be evaluated, for example, based on its ability to predict the hidden states for a given sequence of outputs, often using the Viterbi algorithm. Performance metrics could include the accuracy, precision, recall, F1-score, or area under the Receiver Operating Characteristic (ROC) curve (AUC-ROC).

Block 660, the Risk Assessment process, can then leverage the validated model to estimate the security risk levels of various software projects. This process can entail generating predictions for different project components, such as individual code files, modules, or development processes, and aggregating these predictions to derive a final risk assessment. Aggregation methods might include simple averaging, weighted averaging based on component importance, or more advanced techniques like ensemble methods, Bayesian inference, or probabilistic graphical models.

Risk Assessment Block 660 is where the trained and validated model is implemented to estimate the security risk levels of microservice (or other software) projects. For HMMs, this would involve inferring the most likely sequence of hidden states for a given sequence of code changes, commits, or bug reports. This process, known as decoding, can be performed using the Viterbi algorithm, which finds the most likely sequence of hidden states that could have produced the observed data.

The risk assessment results might be aggregated to derive a final risk assessment for each project or module. Aggregation methods could range from simple averaging to more complex techniques. For instance, with HMMs, the final risk level could be determined by the majority of the inferred hidden states, or the state at the final time point, depending on the specific context and requirements.

Next, the process may proceed to the Risk Classification process at block 670. Here, the estimated security risk levels are categorized into different states, such as high-risk (red), medium-risk (yellow), and low-risk (green). This process can simplify the complex output of risk assessment into more actionable labels that developers and security teams can easily interpret and act upon.

Visualization and Reporting, block 680, can be an important aspect of the process. Here, visualizations such as risk matrices, heat maps, or charts can be generated to make the risk assessment results more comprehensible. Reporting tools can provide detailed insights into specific risks, their causes, potential mitigation strategies, and improvement suggestions. Reporting formats might range from static reports in PDF or HTML formats to interactive dashboards using tools like Tableau or Power BI.

Lastly, at block 690, a Review process can provide a final check and balance to the automated labeling process. A user-friendly interface may be provided to allow the application security team to review the risk assessment results, identify false positives, and provide feedback for model refinement. The review process can be enhanced with various features, such as annotation tools, collaborative features, or data visualization capabilities.

The Review process, certain additional characteristics and functionality may be implemented in some embodiments. The premise of these additional capabilities is the discernible repetition of sequences, for instance, the transition of a microservice's security state from “GREEN” to “YELLOW” in scenarios where the release of the component has aged, thereby potentially escalating vulnerabilities as malevolent entities may have had adequate time for patch difference analysis and exploit development. Consequently, a labeling method that not only takes into account the present state of a microservice but also its security history may be applied to predict labels.

In certain embodiments, such a method may exploit the statistical properties of Hidden Markov Models (HMM). The HMM is an effective model for sequence data, irrespective of whether the data originates from continuous or discrete probability distributions. It aims to estimate the state responsible for the observation, akin to state space and Gaussian mixture models. However, the states in HMM are unknown or ‘hidden’, and the model attempts to estimate these states, functioning akin to an unsupervised clustering procedure.

The core notion of this labeling approach is to generate a distinct intermediate representation for each observed microservices release state, which concurrently serves as an indicator of a security result (e.g., RED, YELLOW, GREEN) and a display of security tools result (e.g., R0.0, R1.0, R1.1, etc.). Consequently, the release history can be depicted as a graph showcasing potential release states and the probabilities of state transitions.

In specific instances, the accuracy of the results can be assessed using the True Positive Rate (TPR), computed as follows: TPR=TP/(TP+FN). Here, ‘TP’ denotes True Positive, i.e., alerts reviewed by the Application Security (AppSec) team and deemed to be relevant security alerts, while ‘FN’ stands for False Negative, i.e., relevant security alerts that were filtered.

The FN value can often be calculated with ease in test scenarios as these values are known and can be readily acquired from release artifacts. However, in instances where manual result labeling by the AppSec team during system usage on production is absent, FN metrics may not be available. In such cases, an alternative approach may involve selecting 10% of the filtered data for re-examination by the AppSec team.

By employing this labeling method, a solution may be developed using an HMM, for example, using the depmixS4 package to fit the HMM. This allows for easier estimation of the current state of the process using posterior probabilities. As per the solution, the security estimation of a release can proceed in the following manner: Sensors generate telemetry comprising artifacts for each layer of the microservice: the telemetry is channeled into the auto labeling system, where the release is marked using the method and filtered based on the security score. If the label is not “GREEN”, the telemetry is sent to the AppSec team for manual review: if the label is “GREEN”, the telemetry is attached to the microservice security report and dispatched to the Development Team (DevTeam).

In some embodiments, the system defaults to the worst-case scenario states of “GREEN” and “RED”. In some examples, the threshold of accuracy for “GREEN→RED” transitions may be set at a specific level, such as 85%. Any score exceeding this threshold, for instance, 86% or higher, could lead to an automatic reclassification from “GREEN” to “RED”. This signifies that the release has a high probability of being vulnerable and therefore needs to be reviewed by the AppSec team immediately.

Conversely, in some embodiments, a lower threshold may be set for “RED→GREEN” transitions, say 70%. This means that if the score dips below this threshold, the system would automatically reclassify the state from “RED” to “GREEN”, indicating that the release's security vulnerabilities have been addressed effectively.

The chosen thresholds can be adjusted as needed based on past performance and feedback from the AppSec and DevTeams. By employing such a system, the aim is to maximize the accuracy of predictions, optimize resource allocation, and improve response times, all while ensuring the highest level of security.

Moreover, in instances where the system encounters a release state it has never seen before, or if it cannot confidently assign a label due to ambiguous or insufficient data, it could default to a ‘safe’ state, typically “RED”, to err on the side of caution. This way, the system can ensure that any potential vulnerabilities aren't overlooked, therefore maintaining the integrity of the security apparatus.

This serves as an integral element within the overarching vulnerability labeling framework. The utilization of HMM models, machine learning models and sophisticated algorithms accelerates and enhances the accuracy of the labeling process, human intuition and expertise can also play an important role, adding an essential layer of validity check and practical wisdom.

The review process acts as a vital bridge between the automated process and the human expertise embodied by the application security team. It underscores the importance of human judgment in a domain that, despite its technological orientation, still necessitates human understanding and discretion. This process provides the opportunity for the security team to scrutinize and verify the automatically generated risk labels, thus offering a human touch to the highly technical process. By accounting for security history and utilizing a flexible threshold system for state transitions, the system can adapt to evolving security scenarios, minimize manual intervention, and thereby enhance overall security efficiency.

In some embodiments, a user interface can present the risk assessment results in an easily comprehensible format, allowing the security team to identify potential anomalies or inaccuracies quickly, such as false positives or negatives. The interface can be designed with intuitive navigation and clear visual elements to ensure a seamless user experience, regardless of the user's technical proficiency.

To further aid the review process, annotation tools could be integrated into the system. These tools can allow the security team members to highlight certain aspects, add comments, or provide feedback directly within the system. These annotations can serve dual purposes. First, they can facilitate internal discussions within the team, fostering collaborative decision-making. Second, they can serve as valuable inputs for refining the model and the overall process, as they provide real-world insights and expert judgments that might be missed by the automated system.

In some embodiments, collaborative features can enrich the review process. These features can include shared dashboards, threaded discussions, or collaborative editing capabilities, enabling real-time collaboration and discussions among the team members. The collaborative features can promote knowledge sharing, collective problem solving, and consensus building, enhancing the overall efficiency and effectiveness of the review process.

Data visualization capabilities can also play a crucial role in the review process. By presenting the risk assessment results in visual forms, such as charts, graphs, heatmaps, or interactive dashboards, the system can make complex data more understandable and actionable. The visualization tools can enable the security team to grasp the overall security posture quickly, identify trends or patterns, and drill down to specific aspects for detailed analysis. Moreover, they can make the review process more engaging and insightful, aiding in decision-making and strategic planning.

Moreover, the review process can be an ongoing iterative process. The feedback and insights derived from the review process can feed back into the system, leading to continuous model refinement and process improvement. The system can be designed to learn from the feedback, adjust the model parameters or decision rules, and adapt over time to improve the labeling accuracy and adapt to changing environments.

In terms of system components, various modules (e.g., of system 300) can be incorporate to perform one or more process blocks. For instance, a Data Collection Module can integrate with a variety of data sources. A Model Implementation Module could handle the selection, training, and evaluation of different models. A Security State Categorization Module might apply classification rules to the model's output. A Manual Review Module may facilitate the review and refinement of the automated labeling results. An Integration Module could ensure seamless integration with existing software development tools and processes.

As such, Process 600 allows organizations to implement an automated vulnerability labeling system that can be tailored to specific needs and preferences, offering flexibility and adaptability to meet diverse requirements. It provides a comprehensive and detailed framework that incorporates a wide range of alternatives, options, technical details, and algorithms for each process block. The specific implementation details and choices can be fine-tuned based on the organization's specific needs, available data sources, and technological capabilities.

Process 600, being highly customizable and adaptable, empowers organizations to implement an automated vulnerability labeling system tailored to their specific needs and requirements. The options, alternatives, technical details, and algorithms mentioned provide a comprehensive understanding of the components and steps involved in the process. Implementation details and specific choices can be further refined and adjusted based on the organization's needs, available data sources, and technological capabilities.

### Computer Device for Performing Automated Security Assessment

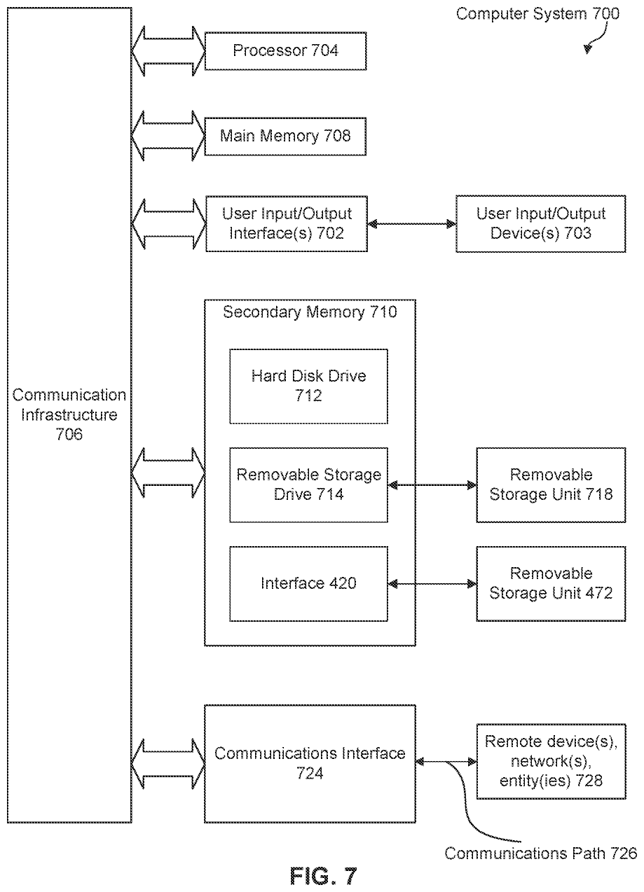

FIG. 7 is a block diagram of example components of device 700. One or more computer systems 700 may be used, for example, to implement any of the embodiments discussed herein, as well as combinations and sub-combinations thereof. Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 308, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714.

Removable storage drive 714 may interact with a removable storage unit 718. Removable storage unit 718 may include a computer-usable or readable storage device having stored thereon computer software (control logic) and/or data. Removable storage unit 718 may be program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions: local or on-premises software (“on-premise” cloud-based solutions): “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A system for performing automated security assessment of microservices in a cloud platform, comprising:
a microservice module comprising a set of microservices, each microservice comprising one or more rules as a separate project following its own development lifecycle for enhanced observability and precise risk score estimations;
a data gathering component configured to collect microservice release information including microservice source code, source code dependencies, and runtime environment;
a security assessment component comprising one or more automatic and semi-automatic tools to analyze the microservice source code, track vulnerabilities in third-party dependencies, and/or identify vulnerabilities in the runtime environment; and
a labeling component configured to assign a security state label to each microservice based on scores obtained from a set of security rules, wherein the labeling component employs one or more models to predict the security state of microservices based on historical data, the one or more models selected from: a hidden Markov model (HMM), a Regression Analysis, a Random Forest, an Artificial Neural Network (ANN), a Support Vector Machines (SVM), an Artificial Intelligence (AI) Model, and a Bayesian Network.

2. The system of claim 1, wherein the one or more models is the hidden Markov model (HMM).

3. The system of claim 1, wherein the microservice composition model enables isolation of engineering risks from business risks.

4. The system of claim 1, wherein the data gathering component interfaces with version control systems or repositories to extract the microservice source code.

5. The system of claim 1, wherein the data gathering component utilizes APIs and/or scraping techniques to gather information about source code dependencies from package managers, build files, or manifest files associated with the microservices.

6. The system of claim 1, wherein the security assessment component integrates with security tools via APIs or command-line interfaces to perform static code analysis, dynamic analysis, software composition analysis, and container vulnerability scanning.

7. The system of claim 1, wherein the microservice release information further includes metadata about the base image and runtime environment used by the microservices.

8. The system of claim 1, wherein the security assessment component generates detailed reports and findings, including lists of security vulnerabilities, associated scores or severity levels, and evidence or descriptions of the vulnerabilities.

9. The system of claim 1, wherein the labeling component assigns the security state label based on cumulative scores obtained from the security rules.

10. The system of claim 1, wherein the security state label comprises “RED” for microservices requiring immediate attention, “YELLOW” for microservices at risk, and “GREEN” for microservices meeting security standards.

11. A method for automated security assessment of microservices in a Cloud Platform, comprising:
collecting microservice release information including microservice source code, source code dependencies, and runtime environment;
performing security assessments at each layer by analyzing the microservice source code, tracking vulnerabilities in third-party dependencies, and identifying vulnerabilities in the runtime environment;
assigning a security state label to each microservice based on scores obtained from a set of security rules; and
predicting the security state of microservices based on historical data using a hidden Markov model.

12. The method of claim 11, further comprising generating a security report for each microservice, including details of identified vulnerabilities, their severity levels, and recommended remediation actions.

13. The method of claim 11, wherein the security assessments at each layer are performed using a combination of static code analysis, dynamic analysis, software composition analysis, and container vulnerability scanning techniques.

14. The method of claim 11, wherein the security state label comprises a color-coded indicator representing the overall security status of each microservice, with “RED” indicating immediate attention required, “YELLOW” indicating at-risk status, and “GREEN” indicating compliance with security standards.

15. The method of claim 11, further comprising integrating the security state labels with a security dashboard or monitoring system to provide real-time visibility into the security posture of the microservices.

16. A computer-readable medium storing instructions that, when executed by a processor, cause the processor to perform a method for automated security assessment of microservices in a Cloud Platform, the method comprising:
collecting microservice release information including microservice source code, source code dependencies, and runtime environment;
performing security assessments at each layer by analyzing the microservice source code, tracking vulnerabilities in third-party dependencies, and identifying vulnerabilities in the runtime environment;
assigning a security state label to each microservice based on scores obtained from a set of security rules; and
predicting the security state of microservices based on historical data using a hidden Markov model.

17. The computer-readable medium of claim 16, wherein the instructions further cause the processor to generate a visual representation of the predicted security states of the microservices based on the hidden Markov model analysis.

18. The computer-readable medium of claim 16, wherein the instructions further cause the processor to incorporate machine learning techniques to improve the accuracy of the hidden Markov model predictions over time.

19. The computer-readable medium of claim 16, wherein the instructions further cause the processor to provide recommendations for security enhancements based on the predicted security states and identified vulnerabilities.

20. The computer-readable medium of claim 16, wherein the instructions further cause the processor to track and store historical security data to continuously update and refine the hidden Markov model for more accurate security state predictions.
